(19) United States
(12) Patent Application Publication
(10) Pub. No.: US 2020/0320276 A1
(43) Pub. Date: Oct. 8, 2020

(54) INFORMATION PROCESSING SYSTEM AND METHOD

(71) Applicant: iiNumbers, Inc., Taipei City (TW)

(72) Inventor: Chia-Chi Chang, Taipei City (TW)

(21) Appl. No.: 16/834,089

(22) Filed: Mar. 30, 2020

Related U.S. Application Data
(60) Provisional application No. 62/828,508, filed on Apr. 3, 2019.

(51) Int. Cl. G06K 9/00; G06N 20/00; G06T 7/593

(52) U.S. Cl. CPC G06K 9/00201; G06T 7/593; G06N 20/00

(57) ABSTRACT

Disclosed is an information processing system and method, applicable to an environment of two-dimensional image/three-dimensional object recognition using artificial intelligence AI. When using the information processing system of the present invention to perform an information processing method, a data processing operation is performed to determine the event status of the two-dimensional image/three-dimensional stereo information. Then, an event processing action is performed to determine the event status of the two-dimensional image/three-dimensional stereo information, The abnormal event status of the two-dimensional image/three-dimensional information means that an object can not be completely identified, but an object information corresponding to the object is produced, and an identification processing, such as artificial identification/identification processing, and/or, artificial intelligence AI methods, is performed according to the object information to find out what object is most likely represented by the object information.

### CROSS-REFERENCE TO RELATED APPLICATION

This application claims the priority of U.S. provisional application No. 62/828,508, filed Apr. 3, 2019, which is incorporated herewith by reference.

### BACKGROUND OF THE INVENTION

### 1. Field of the Invention

The technical field generally relates to an information processing system and method, and in particular, to an information processing system and method, applicable to an environment of two-dimensional image/three-dimensional object recognition using artificial intelligence AI.

### 2. The Prior Arts

For the current artificial intelligence AI recognition, when the unrecognizable situation occurs, only artificial recognition processing can be used to manually identify and mark all or part of the picture/image that can not be recognized. And artificial intelligence AI recognition processing can only be performed on two-dimensional pictures/images information, and can not be performed on three-dimensional stereo information.

Taiwan Patent No. 1621013 “Systems for monitoring application servers” disclosed a monitoring system comprising a communication device, configured to provide a network connection to the Internet and one or more application servers on the Internet; a storage device, configured to store computer-executable instructions or program code; and a controller, configured to load and execute the computer-executable instructions or program code to monitor the application servers, wherein the monitoring of the application servers comprises: initiating a first process to serve as a first task agent for determining whether there is a monitoring item among the application servers and generating a monitoring task when there is a monitoring item among the application servers; initiating a second process to serve as a second task agent for obtaining monitoring data by monitoring the monitoring item according to the monitoring task; initiating a third process to serve as a third task agent for determining whether the monitoring data meets an abnormality definition associated with the monitoring task and generating an alert message when the monitoring data meets the abnormality definition; and initiating a fourth process to serve as a fourth task agent for determining, according to an alert rule, whether or not to send the alert message to a manager of the application server with which the monitoring item is associated.

Taiwan Patent No. 1598286 “FLUID DISPENSER, FLUID DISPENSATION CONTROL DEVICE, AND FLUID DISPENSATION ABNORMAL STATUS MONITOR” disclosed a fluid dispenser, including: a fluid dispensation pipe, for receiving a fluid and controlling a dispensation the fluid; a MEMS sensor, for sensing a movement of the fluid dispenser, wherein when the movement is determined to be in an abnormal status, the MEMS sensor generates an alarm signal; and a dispensation stopper, for stopping the dispensation of the fluid according to the alarm signal.

Taiwan Patent No. 1582732 “MULTIMEDIA PLAYING SYSTEM FOR AUTOMATICALLY NOTIFYING ABNORMAL SITUATIONS AND INFORMATION PROCESSING METHOD OF THE SAME” disclosed a multimedia playing system for automatically notifying abnormal situations having a TV dongle and a network security camera connected to the TV dongle through network. The TV dongle has an email processing server module. The network security camera has an email transmitting module. When the network security camera detects an abnormal situation, an event message is transmitted to the email processing server module. The email processing server module accordingly generates a command. According to the command, the TV dongle transmits a control signal to control a digital TV to immediately display the abnormal situation. Therefore, the multimedia playing system automatically informs a user of the occurrence of the normal situation.

Taiwan Patent Pub. No. 201737084 “Abnormality monitoring method and device” disclosed an abnormality monitoring method and device. The abnormality monitoring device includes: determining, according to reference tasks predetermined in a task scheduling system, an abnormal task in the task scheduling system; determining, according to a reference completion time of the predetermined reference task, a latest starting time for re-activating the abnormal task; and performing an alert process with respect to the abnormal task according to the latest starting time for re-activating the abnormal task and the current time. The present invention increases the flexibility of abnormal task alerts, and reduces non-timely alerts as well as the probability of unnecessary alerts, hence enhancing alert accuracy.

Taiwan Patent Pub. No. 201619921 “Environment abnormality monitoring system and method” disclosed an environment abnormality monitoring system and method, which comprises an image capturing unit and a processing unit. The image capturing unit obtains several consecutive images, and the processing unit comprises a background determination module, an image comparison module, and a marking module. The background determination module analyzes a background image from the consecutive images. The image comparison module compares whether the consecutive images contain an object different from the background image. According to the comparison result of the image comparison module, the marking module marks the object different from the background image.

Therefore, the issues remained to be solved include that for the current artificial intelligence AI recognition, when the unrecognizable situation occurs, only artificial recognition processing can be used to manually identify and mark all or part of the picture/image that can not be recognized, and artificial intelligence AI recognition processing can only be performed on two-dimensional pictures/images information, and can not be performed on three-dimensional stereo information, how to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and how to perform processes of manual identification/recognition processing of the Global Model Localization (including Object Localization and Deep Learning Model Localization) for all or part of two-dimensional image/three-dimensional stereo information.

### SUMMARY OF THE INVENTION

A main object of the present invention is to provide an information processing system and method, applicable to an environment of two-dimensional image/three-dimensional object recognition using artificial intelligence AI. When using the information processing system of the present invention to perform an information processing method, the first step is to perform a data processing operation, wherein a comparison processing is performed on the input two-dimensional image/three-dimensional stereo information, and the event status of the two-dimensional image/three-dimensional stereo information is determined. Then, a step is to perform event processing action, wherein if all of the two-dimensional image/three-dimensional stereo information can be identified, the event status of the two-dimensional image/three-dimensional stereo information is normal, and the subsequent information processing of the two-dimensional image/three-dimensional stereo information is performed, and wherein if all the two-dimensional image/three-dimensional information can not be completely identified, the event status of the two-dimensional image/three-dimensional information would be abnormal. The abnormal event status of the two-dimensional image/three-dimensional information means that an object can not be completely identified, but an object information corresponding to the object (the incompletely identified object) is produced, and an identification processing, such as artificial identification/identification processing, and/or, artificial intelligence AI methods, is performed according to the object information to find out what object is most likely represented by the object information.

Another object of the present invention is to provide an information processing system and method, applicable to an environment of two-dimensional image/three-dimensional stereo recognition using artificial intelligence AI, to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimension image/three-dimensional stereo information.

Yet another object of the present invention is to provide an information processing system and method, applicable to an environment of two-dimensional image/three-dimensional object recognition using artificial intelligence AI, not only to use artificial recognition processing to perform processes of manual identification/recognition processing of the Global Model Localization (including Object Localization and Deep Learning Model Localization) for all or part of two-dimensional image/three-dimensional stereo information that can not be recognized, but also to perform artificial intelligence AI methods to find out what object is most likely represented by the all or part of two-dimensional image/three-dimensional information.

To achieve the aforementioned objects, the present invention provides an information processing system, comprising: an artificial intelligence AI processing module, and a database.

The Artificial intelligence AI processing module cooperates with the database for a data processing operation, wherein a comparison processing is performed on the input two-dimensional image/three-dimensional stereo information, and the event status of the two-dimensional image/three-dimensional stereo information is determined.

Then, an event processing action is performed by the Artificial intelligence AI processing module cooperating with the database, wherein if all of the two-dimensional image/three-dimensional stereo information can be identified, the event status of the two-dimensional image/three-dimensional stereo information is normal, and the subsequent information processing of the two-dimensional image/three-dimensional stereo information is performed, and wherein if all the two-dimensional image/three-dimensional stereo information can not be completely identified, the event status of the two-dimensional image/three-dimensional stereo information would be abnormal.

The abnormal event status of the two-dimensional image/three-dimensional stereo information means that an object can not be completely identified, but an object information corresponding to the object (the incompletely identified object) is produced, and an identification processing, such as artificial identification/identification processing, and/or, artificial intelligence AI methods, is performed according to the object information to find out what object is most likely represented by the object information.

The data processing operation and the event processing action both are performed by the Artificial intelligence AI processing module cooperating with the database to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

The database can store data needed by the artificial intelligence AI processing module, which is the data of the pre-learning and/or the deep learning and/or the automatic machine learning of top-down AI approach and/or the neural network/neural network-like function/algorithm for strong artificial intelligence (bottom-up AI), and/or the algorithm data for operations; and, meanwhile, can store the data needed for performing processes of manual identification/recognition processing of the Global Model Localization (including Object Localization and Deep Learning Model Localization) for all or part of two-dimensional image/three-dimensional stereo information that can not be recognized.

When using the information processing system of the present invention to perform an information processing method, the first step is to perform a data processing operation, wherein the data processing operation is performed by the artificial intelligence AI processing module cooperating with the database, and a comparison processing is performed on the input two-dimensional image/three-dimensional stereo information and the event status of the two-dimensional image/three-dimensional stereo information is determined.

Then, a step is to perform event processing action, wherein the data processing operation is performed by the Artificial intelligence AI processing module cooperating with the database, wherein if all of the two-dimensional image/three-dimensional stereo information can be identified, the event status of the two-dimensional image/three-dimensional stereo information is normal, and the subsequent information processing of the two-dimensional image/three-dimensional stereo information is performed, and wherein if all the two-dimensional image/three-dimensional stereo information can not be completely identified, the event status of the two-dimensional image/three-dimensional stereo information would be abnormal.

The abnormal event status of the two-dimensional image/three-dimensional stereo information means that an object can not be completely identified, but an object information corresponding to the object (the incompletely identified object) is produced, and an identification processing, such as artificial identification/identification processing, and/or, artificial intelligence AI methods, is performed according to the object information to find out what object is most likely represented by the object information.

The data processing operation and the event processing action both are performed by the Artificial intelligence AI processing module cooperating with the database to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 is a schematic view of an information processing system according to present invention;

FIG. 2 is a flowchart to illustrate an information processing method by utilizing the information processing system in FIG. 1 of the present invention;

FIG. 3 is a schematic view of an embodiment of the information processing system according to present invention;

FIG. 4 is a flowchart to illustrate an embodiment of the information processing method by utilizing the embodiment of the information processing system in FIG. 3 of the present invention;

FIG. 5 is a schematic view of another embodiment of the information processing system according to present invention;

FIG. 6 is a flowchart to illustrate another embodiment of the information processing method by utilizing the embodiment of the information processing system in FIG. 5 of the present invention;

FIG. 7 is a schematic view of another embodiment of the information processing system according to present invention; and

FIG. 8 is a flowchart to illustrate another embodiment of the information processing method by utilizing the embodiment of the information processing system in FIG. 7 of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

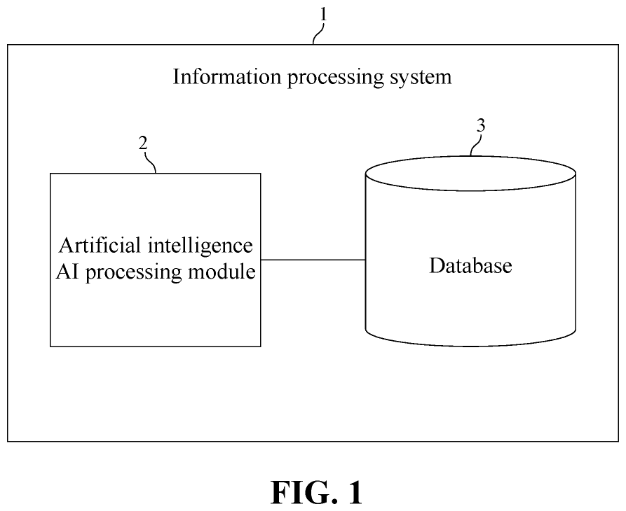

FIG. 1 is a schematic view of an information processing system according to present invention. As shown in FIG. 1, an information processing system 1 comprises an artificial intelligence AI processing module 2, and a database 3.

The Artificial intelligence AI processing module 2 cooperates with the database 3 for a data processing operation, wherein a comparison processing is performed on the input two-dimensional image/three-dimensional stereo information, and the event status of the two-dimensional image/three-dimensional stereo information is determined.

Then, an event processing action is performed by the artificial intelligence AI processing module 2 cooperating with the database 3, wherein if all of the two-dimensional image/three-dimensional stereo information can be identified, the event status of the two-dimensional image/three-dimensional stereo information is normal, and the subsequent information processing of the two-dimensional image/three-dimensional stereo information is performed, and wherein if all the two-dimensional image/three-dimensional stereo information can not be completely identified, the event status of the two-dimensional image/three-dimensional stereo information would be abnormal. The abnormal event status of the two-dimensional image/three-dimensional stereo information means that an object can not be completely identified, but an object information corresponding to the object (the incompletely identified object) is produced, and an identification processing, such as artificial identification/identification processing, and/or, artificial intelligence AI methods, is performed according to the object information to find out what object is most likely represented by the object information.

The data processing operation and the event processing action both are performed by the artificial intelligence AI processing module 2 cooperating with the database 3, to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

The database 3 can store data needed by the artificial intelligence AI processing module 2, which is the data of the pre-learning and/or the deep learning and/or the automatic machine learning of top-down AI approach and/or the neural network/neural network-like function/algorithm for strong artificial intelligence (bottom-up AI), and/or the algorithm data for operations; and, meanwhile, can store the data needed for performing processes of manual identification/recognition processing of the Global Model Localization (including Object Localization and Deep Learning Model Localization) for all or part of two-dimensional image/three-dimensional stereo information that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

The information processing system 1 is inside an electronic system or an electronic device, the artificial intelligence AI processing module 2 is composed of at least one of the hardware, firmware, and software, and is cooperated with a processor of the electronic system or the electronic device to perform operations, and the database 3 is inside the storage module of the electronic system or the electronic device.

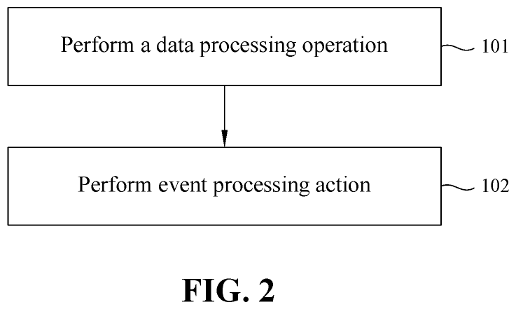

FIG. 2 is a flowchart to illustrate an information processing method by utilizing the information processing system in FIG. 1 of the present invention. As shown in FIG. 2, firstly, step 101 is to perform a data processing operation, wherein the data processing operation is performed by the artificial intelligence AI processing module 2 cooperating with the database 3, and a comparison processing is performed on the input two-dimensional image/three-dimensional stereo information and the event status of the two-dimensional image/three-dimensional stereo information is determined; and then proceed to Step 102.

Step 102 is to perform event processing action, wherein the data processing operation is performed by the artificial intelligence AI processing module 2 cooperating with the database 3, wherein if all of the two-dimensional image/three-dimensional stereo information can be identified, the event status of the two-dimensional image/three-dimensional stereo information is normal, and the subsequent information processing of the two-dimensional image/three-dimensional stereo information is performed, and wherein if all the two-dimensional image/three-dimensional stereo information can not be completely identified, the event status of the two-dimensional image/three-dimensional stereo information would be abnormal.

The abnormal event status of the two-dimensional image/three-dimensional stereo information means that an object can not be completely identified, but an object information corresponding to the object (the incompletely identified object) is produced, and an identification processing, such as artificial identification/identification processing, and/or, artificial intelligence AI methods, is performed according to the object information to find out what object is most likely represented by the object information.

The data processing operation in the step 101 and the event processing action in the step 102 both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

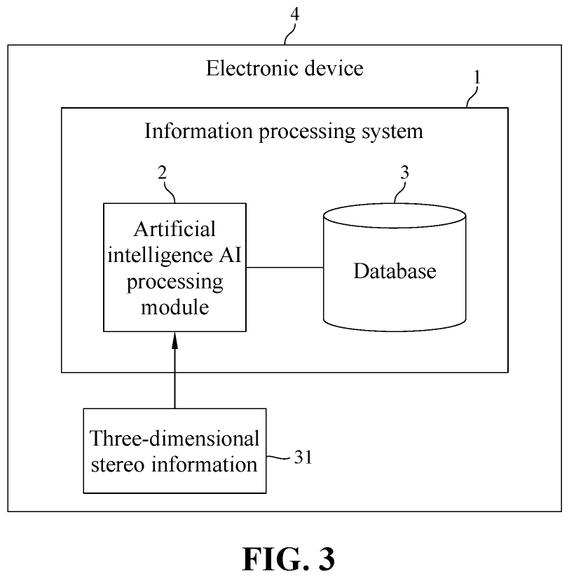

FIG. 3 is a schematic view of an embodiment of the information processing system according to present invention. As shown in FIG. 3, an information processing system 1 comprises an artificial intelligence AI processing module 2, and a database 3, wherein the information processing system 1 is inside an electronic device 4, such as a server, the artificial intelligence AI processing module 2 is composed of at least one of the hardware, firmware, and software, and is cooperated with a processor of the electronic device 4 to perform operations, and the database 3 is inside the storage module of the electronic device 4.

The artificial intelligence AI processing module 2 cooperates with the database 3 for a data processing operation, wherein a comparison processing is performed on the input three-dimensional stereo information 31, and the event status of the three-dimensional stereo information 31 is determined.

Then, an event processing action is performed by the artificial intelligence AI processing module 2 cooperating with the database 3, wherein all of the three-dimensional stereo information 31 can be identified, the event status of the two-dimensional image/three-dimensional stereo information is normal, and the subsequent information processing of the three-dimensional stereo information 31 is performed.

The data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information.

The database 3 can store data needed by the artificial intelligence AI processing module 2, which is the data of the pre-learning and/or the deep learning and/or the automatic machine learning of top-down AI approach and/or the neural network/neural network-like function/algorithm for strong artificial intelligence (bottom-up AI), and/or the algorithm data for operations; and, meanwhile, can store the data needed for performing processes of manual identification/recognition processing of the Global Model Localization (including Object Localization and Deep Learning Model Localization) for all or part of two-dimensional image/three-dimensional stereo information that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

In this embodiment, although the electronic device 4 is a server, however, the electronic device 4 can also be, for example, a PC, a mobile phone, or a Tablet; the data processing operation and the event processing action both are performed by the artificial intelligence AI processing module 2 cooperating with the database 3 for processing the three-dimension stereo information, and, however, it can also can be applied for processing the two-dimension information.

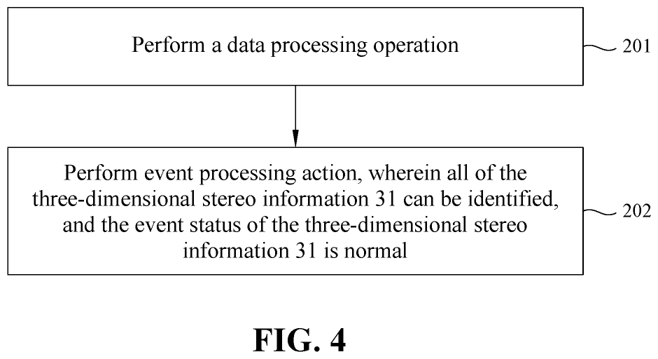

FIG. 4 is a flowchart to illustrate an embodiment of the information processing method by utilizing the embodiment of the information processing system of the present invention in FIG. 3. As shown in FIG. 4, firstly, step 201 is to perform a data processing operation, wherein the data processing operation is performed by the artificial intelligence AI processing module 2 cooperating with the database 3, and a comparison processing is performed on the input three-dimensional stereo information 31 and the event status of the three-dimensional stereo information 31 is determined; and then proceed to Step 202.

Step 202 is to perform event processing action, wherein the data processing operation is performed by the artificial intelligence AI processing module 2 cooperating with the database 3, wherein all of the three-dimensional stereo information 31 can be identified, the event status of the three-dimensional stereo information 31 is normal, and the subsequent information processing of the three-dimensional stereo information 31 is performed.

The data processing operation in the step 201 and the event processing action in the step 202 both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimensional stereo information 31.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimensional stereo information 31.

In this embodiment, although the electronic device 4 is a server, however, the electronic device 4 can also be, for example, a PC, a mobile phone, or a Tablet; the data processing operation and the event processing action both are performed by the artificial intelligence AI processing module 2 cooperating with the database 3 for processing the three-dimension stereo information, and, however, it can also can be applied for processing the two-dimension information.

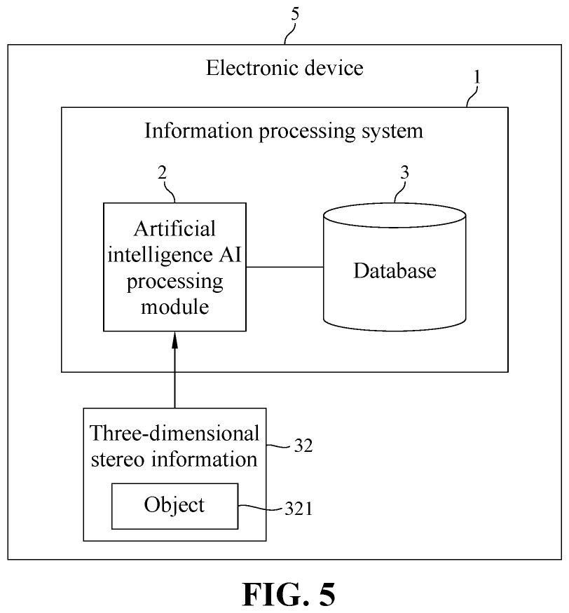

FIG. 5 is a schematic view of another embodiment of the information processing system according to present invention. As shown in FIG. 5, an information processing system 1 comprises an artificial intelligence AI processing module 2, and a database 3, wherein the information processing system 1 is inside an electronic device 5, such as a PC, the artificial intelligence AI processing module 2 is composed of at least one of the hardware, firmware, and software, and is cooperated with a processor of the electronic device 5 to perform operations, and the database 3 is inside the storage module of the electronic device 5.

The artificial intelligence AI processing module 2 cooperates with the database 3 for a data processing operation, wherein a comparison processing is performed on the input three-dimensional stereo information 32, and the event status of the three-dimensional stereo information 32 is determined.

Then, an event processing action is performed by the artificial intelligence AI processing module 2 cooperating with the database 3, wherein if all the three-dimensional information 31 can not be completely identified, the event status of the three-dimensional information 31 would be abnormal.

The abnormal event status of the three-dimensional stereo information 31 means that an object 321 can not be completely identified, but an object information corresponding to the object 321 (the incompletely identified object) is produced, and an identification processing, such as artificial identification/identification processing, and/or, artificial intelligence AI methods, is performed according to the object information to find out what object is most likely represented by the object information.

The data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimensional stereo information 32, and to perform processes of manual identification/recognition processing of the Global Model Localization (including Object Localization and Deep Learning Model Localization) for all or part of the three-dimensional stereo information 32 that can not be recognized.

The database 3 can store data needed by the artificial intelligence AI processing module 2, which is the data of the pre-learning and/or the deep learning and/or the automatic machine learning of top-down AI approach and/or the neural network/neural network-like function/algorithm for strong artificial intelligence (bottom-up AI), and/or the algorithm data for operations; and, meanwhile, can store the data needed for performing processes of manual identification/recognition processing of the Global Model Localization (including Object Localization and Deep Learning Model Localization) for all or part of the object information corresponding to the incompletely identified object 321 of the three-dimension stereo information 32 that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

In this embodiment, although the electronic device 4 is a PC, however, the electronic device 4 can also be, for example, a server, a mobile phone, or a Tablet; the data processing operation and the event processing action both are performed by the artificial intelligence AI processing module 2 cooperating with the database 3 for processing the three-dimension stereo information 32 and determining the event status of the three-dimensional stereo information 32, and, however, it can also can be applied for processing the two-dimension information.

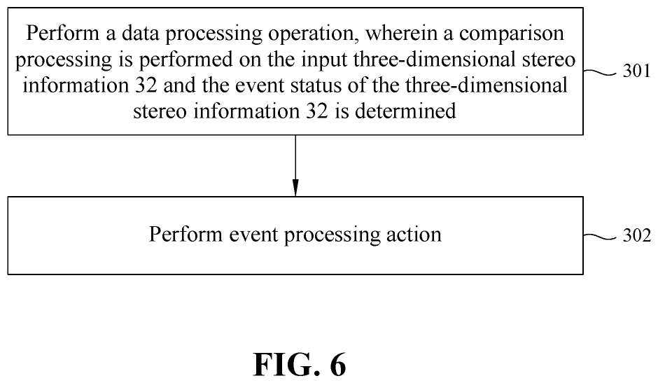

FIG. 6 is a flowchart to illustrate another embodiment of the information processing method by utilizing the embodiment of the information processing system of the present invention in FIG. 5. As shown in FIG. 6, firstly, step 301 is to perform a data processing operation, wherein the data processing operation is performed by the artificial intelligence AI processing module 2 cooperating with the database 3, and a comparison processing is performed on the input three-dimensional stereo information 32 and the event status of the three-dimensional stereo information 32 is determined; and then proceed to Step 302.

Step 302 is to perform event processing action, wherein the data processing operation is performed by the artificial intelligence AI processing module 2 cooperating with the database 3, wherein all the three-dimensional stereo information 32 can not be completely identified, the event status of the three-dimensional stereo information 32 would be abnormal.

The abnormal event status of the three-dimensional stereo information 32 means that an object 321 can not be completely identified, but an object information corresponding to the object 321 (the incompletely identified object) is produced, and an identification processing, such as artificial identification/identification processing, and/or, artificial intelligence AI methods, is performed according to the object information to find out what object is most likely represented by the object information of the object 321.

The data processing operation in the step 301 and the event processing action in the step 302 both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimension stereo information 32, and to perform processes of manual identification/recognition processing of the Global Model Localization (including Object Localization and Deep Learning Model Localization) for all or part of the object information corresponding to the incompletely identified object 321 of the three-dimension stereo information 32 that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

In this embodiment, the data processing operation and the event processing action both are performed by the artificial intelligence AI processing module 2 cooperating with the database 3 for processing the three-dimension stereo information 32 and determining the event status of the three-dimensional stereo information 32, and, however, it can also can be applied for processing the two-dimension information.

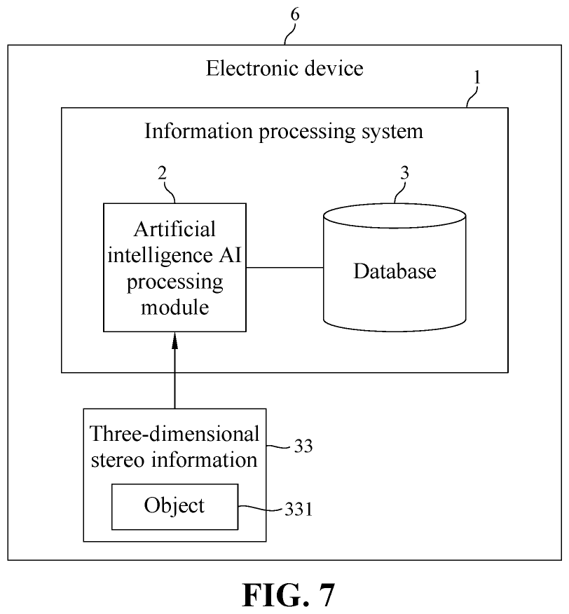

FIG. 7 is a schematic view of another embodiment of the information processing system according to present invention. As shown in FIG. 7, an information processing system 1 comprises an artificial intelligence AI processing module 2, and a database 3, wherein the information processing system 1 is inside an electronic device 6, such as a server, the artificial intelligence AI processing module 2 is composed of at least one of the hardware, firmware, and software, and is cooperated with a processor of the electronic device 6 to perform operations, and the database 3 is inside the storage module of the electronic device 6.

The artificial intelligence AI processing module 2 cooperates with the database 3 for a data processing operation, wherein a comparison processing is performed on the input three-dimensional stereo information 33, and the event status of the three-dimensional stereo information 33 is determined.

Then, an event processing action is performed by the artificial intelligence AI processing module 2 cooperating with the database 3, wherein if all the three-dimensional information 33 can not be completely identified, the event status of the three-dimensional information 33 would be abnormal.

The abnormal event status of the three-dimensional stereo information 33 means that an object 331 can not be completely identified, but an object information corresponding to the object 331 (the incompletely identified object) is produced, and an identification processing, such as artificial intelligence AI methods, is performed according to the object information to find out what object is most likely represented by the object information.

For example, by using the artificial intelligence AI methods, the probability of identifying the object 331 as a cat is more than 80%, and because the probability set value is, for example, 50%, the artificial intelligence AI processing module 2 will determine and assume that the object 331 is a cat according to the probability of identifying the object 331 as a cat is larger than the probability set value, wherein the probability set value can be set up to different percentages depending on different implementation conditions of the present invention.

The data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimension stereo information 33, and to perform processes of manual identification/recognition processing of the Global Model Localization (including Object Localization and Deep Learning Model Localization) for all or part of the three-dimensional stereo information 33 that can not be recognized.

The database 3 can store data needed by the artificial intelligence AI processing module 2, which is the data of the pre-learning and/or the deep learning and/or the automatic machine learning of top-down AI approach and/or the neural network/neural network-like function/algorithm for strong artificial intelligence (bottom-up AI), and/or the algorithm data for operations; and, meanwhile, can store the data needed for performing processes of manual identification/recognition processing of the Global Model Localization (including Object Localization and Deep Learning Model Localization) for all or part of the object information corresponding to the incompletely identified object 331 of the three-dimension stereo information 33 that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of two-dimensional image/three-dimensional stereo information, and to perform processes of manual identification/recognition processing of the Global Model Localization (including Object Localization and Deep Learning Model Localization) for all or part of two-dimensional image/three-dimensional stereo information that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

In this embodiment, although the electronic device 6 is a server, however, the electronic device 6 can also be, for example, a PC, a mobile phone, or a Tablet; the data processing operation and the event processing action both are performed by the artificial intelligence AI processing module 2 cooperating with the database 3 for processing the three-dimension stereo information 33 and determining the event status of the three-dimensional stereo information 33, and, however, it can also can be applied for processing the two-dimension information.

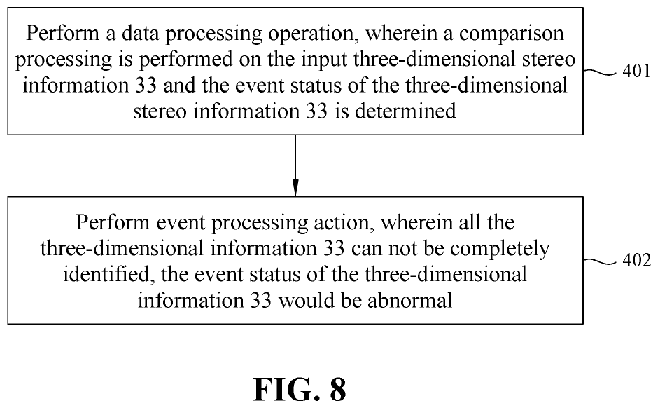

FIG. 8 is a flowchart to illustrate another embodiment of the information processing method by utilizing the embodiment of the information processing system of the present invention in FIG. 7. As shown in FIG. 8, firstly, step 401 is to perform a data processing operation, wherein the data processing operation is performed by the artificial intelligence AI processing module 2 cooperating with the database 3, and a comparison processing is performed on the input three-dimensional stereo information 33 and the event status of the three-dimensional stereo information 33 is determined; and then proceed to Step 402.

Step 402 is to perform event processing action, wherein the data processing operation is performed by the artificial intelligence AI processing module 2 cooperating with the database 3, wherein all the three-dimensional information 33 can not be completely identified, the event status of the three-dimensional information 33 would be abnormal.

The abnormal event status of the three-dimensional information stereo 33 means that an object 331 can not be completely identified, but an object information corresponding to the object 331 (the incompletely identified object) is produced, and an identification processing, such as artificial identification/identification processing, and/or, artificial intelligence AI methods, is performed according to the object information to find out what object is most likely represented by the object information of the object 331.

For example, by using the artificial intelligence AI methods, the probability of identifying the object 331 as a cat is more than 80%, and because the probability set value is, for example, 50%, the artificial intelligence AI processing module 2 will determine and assume that the object 331 is a cat according to the probability of identifying the object 331 as a cat is larger than the probability set value, wherein the probability set value can be set up to different percentages depending on different implementation conditions of the present invention.

The data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimension stereo information 33, and to perform processes of manual identification/recognition processing of the Global Model Localization (including Object Localization and Deep Learning Model Localization) for all or part of the three-dimensional stereo information 33 that can not be recognized.

Depending on the actual implementation of the present invention, the data processing operation and the event processing action both are performed by the artificial intelligence AI processing module 2 cooperating with the database 3 to make full use of pre-learning and/or deep learning and/or automatic machine learning of top-down AI approach and/or neural network/neural network-like function/algorithm for strong artificial intelligence (bottom-up AI) to determine the event status of the three-dimension stereo information 33, and to perform processes of manual identification/recognition processing of the Global Model Localization (including Object Localization and Deep Learning Model Localization) for all or part of the three-dimension stereo information 33 that can not be recognized.

Also, depending on the actual implementation of the present invention, the artificial intelligence AI processing module 2 cooperating with the database 3 can proceed continuous auto-learning processes, and the architecture of the neural network/neural network-like function/algorithm of the top-down AI approach is evolving by the artificial intelligence AI processing module 2 by using the AI mode.

In this embodiment, although the electronic device 6 is a server, however, the electronic device 6 can also be, for example, a PC, a mobile phone, or a Tablet; the data processing operation and the event processing action both are performed by the artificial intelligence AI processing module 2 cooperating with the database 3 for processing the three-dimension stereo information 33 and determining the event status of the three-dimensional stereo information 33, and, however, it can also can be applied for processing the two-dimension information.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An information processing method, applicable to an environment of two-dimensional image/three-dimensional object recognition using artificial intelligence AI, comprising the following steps:
performing a data processing operation, wherein a comparison processing is performed on input two-dimensional image/three-dimensional stereo information, and an event status of the two-dimensional image/three-dimensional stereo information is determined; and
performing an event processing action, wherein corresponding response actions are made according to the event status of the two-dimensional image/three-dimensional stereo information.

2. The information processing method as claimed in claim 1, wherein the event status of the two-dimensional image/three-dimensional stereo information is normal, and subsequent information processing of the two-dimensional image/three-dimensional stereo information is performed.

3. The information processing method as claimed in claim 1, wherein the event status of the two-dimensional image/three-dimensional stereo information is abnormal, an object is not completely identified, an object information corresponding to the object is produced, and an identification processing is performed according to the object information.

4. The information processing method as claimed in claim 3, wherein the identification processing is artificial identification/identification processing.

5. The information processing method as claimed in claim 3, wherein the identification processing is artificial intelligence AI methods.

6. An information processing method, applicable to an environment of two-dimensional image/three-dimensional object recognition using artificial intelligence AI, comprising:
a database; and
an artificial intelligence AI processing module;
wherein the artificial intelligence AI processing module cooperates with the database, and wherein a comparison processing is performed on input two-dimensional image/three-dimensional stereo information, and an event status of the two-dimensional image/three-dimensional stereo information is determined, by the artificial intelligence AI processing module cooperating with the database.

7. The information processing system as claimed in claim 6, wherein the event status of the two-dimensional image/three-dimensional stereo information is normal, and subsequent information processing of the two-dimensional image/three-dimensional stereo information is performed.

8. The information processing system as claimed in claim 6, wherein the event status of the two-dimensional image/three-dimensional stereo information is abnormal, an object is not completely identified, an object information corresponding to the object is produced, and an identification processing is performed according to the object information.

9. The information processing system as claimed in claim 8, wherein the identification processing is artificial identification/identification processing.

10. The information processing system as claimed in claim 8, wherein the identification processing is artificial intelligence AI methods.
